(19) United States
(12) Patent Application Publication
(10) Pub. No.: US 2007/0240519 A1
(43) Pub. Date: Oct. 18, 2007

(54) Mechanical quantity measuring apparatus

(75) Inventors: Hiromi Shimazu, Kashiwa (JP); Hiroyuki Ohta, Tsuchiura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/698,584

(22) Filed: Jan. 25, 2007

(30) Foreign Application Priority Data
Mar. 22, 2006 (JP) 2006-077951

(51) Int. Cl. G01B 7/16

(52) U.S. Cl. 73/777

(57) ABSTRACT

It is an object to prevent breakage of a mechanical quantity measuring apparatus made of a monocrystalline silicon substrate due to a large distortion. A mounting board for measuring distortion is provided on a rear surface of a sensor chip made of a semiconductor monocrystalline substrate having a distortion detecting unit. Even when a large distortion occurs in an object to be measured, a distortion occurring in the semiconductor monocrystalline substrate can be controlled by the mounting board. Therefore, the semiconductor monocrystalline substrate is not broken, and a highly reliable mechanical quantity measuring apparatus can be provided.

### CROSS-REFERENCE TO RELATED APPLICATION

The present application claims priority from Japanese Patent Application No. JP 2006-077951 filed on Mar. 22, 2006, the content of which is hereby incorporated by reference into this application.

### TECHNICAL FIELD OF THE INVENTION

The present invention relates to a mechanical quantity measuring apparatus for measuring a mechanical quantity of an object.

### BACKGROUND OF THE INVENTION

As a technology for measuring a deformation (distortion) of an object to be measured, a technology using a metal foil distortion gauge which utilizes the fact that a resistance value of a metal foil changes due to distortion has been known. In this technology, by adhering the distortion gauge to an object to be measured so that the length of a metal foil is changed along with the distortion of the object to be measured, and the resistance value of the metal foil changed as a result of the distortion is detected, thereby measuring the distortion of the object to be measured.

However, the technology has a problem that, when it is driven by batteries, the batteries are rapidly consumed because the power consumption thereof is large. Thus, the inventors of the present invention have invented a semiconductor mechanical quantity measuring apparatus in which an impurity diffusion resistor (referred to as diffusion resistor, hereinafter) obtained by introducing an impurity into monocrystalline silicon is used as a distortion-sensitive resistor in order to reduce the power consumption of the distortion-sensitive resistor (see Japanese Patent Application Laid-Open Publication No. 2005-114443 (Patent Document 1)).

### SUMMARY OF THE INVENTION

However, since main portions of the semiconductor mechanical quantity measuring apparatus are made of a monocrystalline silicon substrate in the case described above, there is concern that the silicon substrate is broken if a large distortion occurs in an object to be measured.

As the conventional semiconductor mechanical quantity measuring apparatus, a distortion gauge using a polycrystalline silicon thin film for a distortion-sensitive unit has been disclosed. However, a problem of its breakage does not occur because of the thin film. Further, in the case where the entire distortion-sensitive device is a resistive layer as in the conventional distortion gauge, the device is mounted on a soft resin, and in this state, it is attached to an object to be measured. However, in the case of the semiconductor mechanical quantity measuring apparatus using the monocrystalline silicon substrate as in the present invention, when the device is mounted on a soft resin material and then attached to an object to be measured like the conventional technology, a distortion of the object to be measured is not sufficiently transmitted to the distortion-sensitive resistor on the silicon substrate, and consequently, the measuring apparatus cannot exert its function as a measuring apparatus.

An object of the present invention is to provide a mechanical quantity measuring apparatus which can be driven with low power consumption, can perform highly accurate measurement, and has high reliability and enough breakage resistance.

The above object is achieved by measuring a distortion by an apparatus, in which a distortion detecting unit is provided on a main surface of a semiconductor monocrystalline substrate, the semiconductor monocrystalline substrate is mounted on a mounting board, and the mounting board on which the semiconductor monocrystalline substrate is mounted is adhered to or embedded in an object to be measured. The mounting board is appropriately selected according to usage from among one made of metal material, one having a higher Young's modulus than that of the semiconductor monocrystalline substrate, one having a lower Young's modulus than that of the semiconductor monocrystalline substrate, and a filler-containing resin.

According to the present invention, even when a large distortion occurs in an object to be measured, since the mounting board can control a distortion occurring on the semiconductor monocrystalline substrate, the semiconductor monocrystalline substrate is not broken. Accordingly, it is possible to provide a highly reliable mechanical quantity measuring apparatus which can perform the measurement with high accuracy.

### BRIEF DESCRIPTIONS OF THE DRAWINGS

FIG. 1 is a diagram showing a sectional structure of main portions of a mechanical quantity measuring apparatus according to a first embodiment of the present invention;

FIG. 2 is a diagram showing a planar structure of main portions of a mechanical quantity measuring apparatus according to the first embodiment of the present invention;

FIG. 3 is a diagram showing a sectional structure of main portions of a mechanical quantity measuring apparatus according to the first embodiment of the present invention;

FIG. 4 is a diagram showing a flowchart of a method for removing a thermal distortion by a temperature sensor;

FIG. 5 is a diagram showing a planar structure of main portions of a mechanical quantity measuring apparatus according to a second embodiment of the present invention;

FIG. 6 is a diagram showing a sectional structure of main portions of a mechanical quantity measuring apparatus according to the second embodiment of the present invention;

FIG. 7 is a diagram showing a planar structure of main portions of a mechanical quantity measuring apparatus according to the second embodiment of the present invention;

FIG. 8 is a diagram showing a planar structure of main portions of a mechanical quantity measuring apparatus according to the second embodiment of the present invention;

FIG. 9 is a diagram showing a sectional structure of main portions of a mechanical quantity measuring apparatus according to a third embodiment of the present invention;

FIG. 10 is a diagram showing a sectional structure of main portions of a mechanical quantity measuring apparatus according to the third embodiment of the present invention;

FIG. 11 is a diagram showing a sectional structure of main portions of a mechanical quantity measuring apparatus according to a fourth embodiment of the present invention;

FIG. 12 is a diagram showing a planar structure of main portions of a mechanical quantity measuring apparatus according to the fourth embodiment of the present invention;

FIG. 13 is a diagram showing a sectional structure of main portions of a mechanical quantity measuring apparatus according to the fourth embodiment of the present invention;

FIG. 14 is a diagram showing a planar structure of main portions of a mechanical quantity measuring apparatus according to the fourth embodiment of the present invention;

FIG. 15 is a diagram showing a sectional structure of main portions of a mechanical quantity measuring apparatus according to the fourth embodiment of the present invention;

FIG. 16 is a diagram showing a sectional structure of main portions of a mechanical quantity measuring apparatus according to the fourth embodiment of the present invention;

FIG. 17 is a diagram showing a sectional structure of main portions of a mechanical quantity measuring apparatus according to a fifth embodiment of the present invention;

FIG. 18 is a diagram showing a sectional structure of main portions of a mechanical quantity measuring apparatus according to the fifth embodiment of the present invention;

FIG. 19 is a diagram showing a sectional structure of main portions of a mechanical quantity measuring apparatus according to the fifth embodiment of the present invention; and

FIG. 20 is a diagram showing a sectional structure of main portions of a mechanical quantity measuring apparatus according to a sixth embodiment of the present invention.

### DESCRIPTIONS OF THE PREFERRED EMBODIMENTS

Embodiments of the present invention will be described below with reference to the drawings.

### First Embodiment

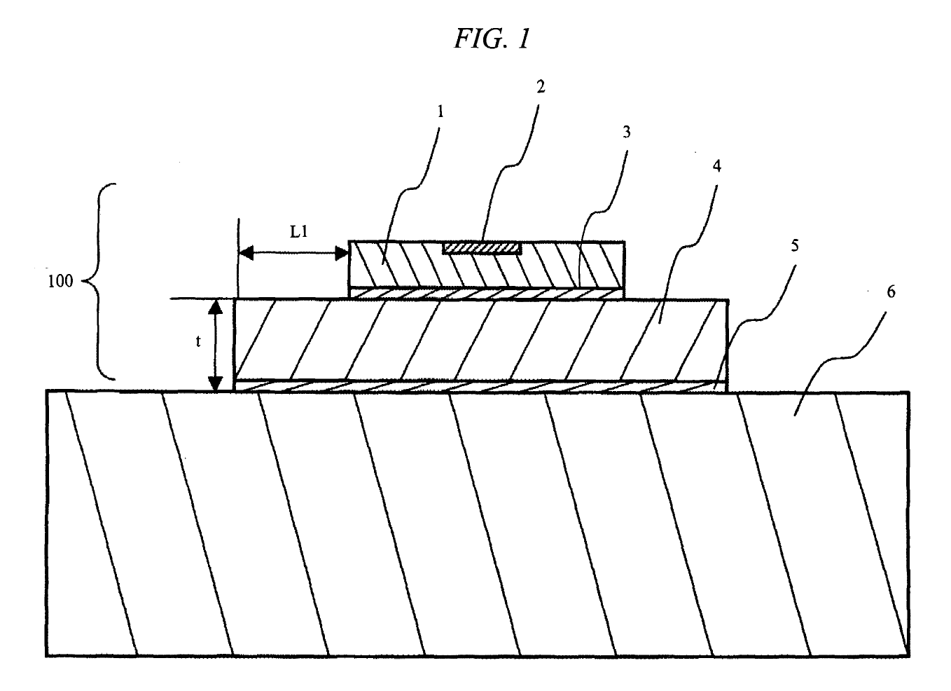

First, a first embodiment of the present invention will be described with reference to FIG. 1 to FIG. 4.

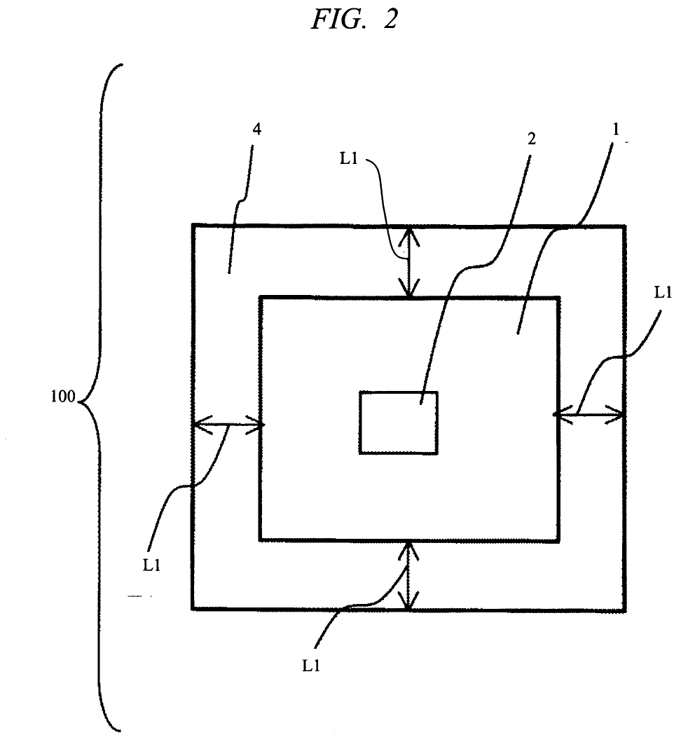

FIG. 1 and FIG. 2 show a sectional structure and a planar structure of main portions of a mechanical quantity measuring apparatus according to the present embodiment. A mechanical quantity measuring apparatus 100 according to the present embodiment shown in FIG. 1 and FIG. 2 is provided with a distortion detecting unit 2 on a main surface la of a monocrystalline silicon substrate 1, and the distortion detecting unit 2 is formed of a Wheatstone bridge circuit made of four impurity diffusion resistors. In this mechanical quantity measuring apparatus 100, a resistance value of the impurity diffusion resistors changed due to the extension/contraction in the planar direction of the silicon substrate 1 caused by a distortion of an object to be measured is detected, thereby detecting the distortion of the object to be measured. Although an electrical resistance value of the impurity diffusion layer may change even due to a temperature, since the Wheatstone bridge is formed of the impurity diffusion layers, an output variation due to a temperature drift can be removed. Accordingly, it is possible to detect the distortion with high accuracy. Further, a silicon substrate rear surface 1b opposite to the silicon substrate main surface 1a is connected to a mounting board 4 via an adhesion layer 3. The distortion detecting unit 2 is formed at the center of the silicon substrate as shown in FIG. 2, and the silicon substrate 1 on which the distortion detecting unit 2 is formed is provided at the center of the mounting board 4.

Though not shown, wirings and pads for extracting an electric signal and insulating material for insulating them are formed according to need. In the present embodiment, the silicon substrate 1 provided on the mounting board 4 via the adhesion layer 3 and a group of thin films formed on the silicon substrate 1 are collectively referred to as a sensor chip, and the sensor chip and the mounting board 4 are collectively referred to as the mechanical quantity measuring apparatus 100.

Also, by providing at least one direction indicating mark on the surface of the mounting board 4, it becomes possible to easily recognize a distortion measuring direction and handle the apparatus.

Next, operations and effects according to the present embodiment will be described. In the case of the semiconductor mechanical quantity measuring apparatus in which the impurity diffusion layers formed on the silicon substrate 1 are used as a distortion-sensitive resistor and a distortion is measured by utilizing a piezo-resistance effect of the impurity diffusion layers, since the main portions thereof are formed of the monocrystalline silicon substrate 1, there is concern that the monocrystalline silicon substrate is broken when a large distortion occurs in an object to be measured. As a conventional semiconductor mechanical quantity measuring apparatus, a distortion gauge using a polycrystalline silicon thin film for a distortion-sensitive unit has been disclosed. However, a problem of the breakage of a silicon substrate does not occur because of the thin film. Further, in the case where the entire distortion-sensitive device is a resistive layer like the conventional distortion gauge, the distortion-sensitive device is mounted on a soft resin (having a low Young's modulus) and then attached to an object to be measured. However, in the semiconductor mechanical quantity measuring apparatus using the monocrystalline silicon substrate according to the present invention, when the device is mounted on a soft resin material and then attached to an object to be measured like the conventional technology, a distortion of the object to be measured is not sufficiently transmitted to the distortion detecting unit 2 because a rigidity of the monocrystalline silicon substrate 1 is high, and consequently, the measuring apparatus cannot exert its functions as the measuring apparatus.

On the other hand, it is necessary to increase a rigidity of the mounting board to a certain degree to improve the sensitivity. However, if a glass substrate is used for the mounting board, there is a problem that the glass is broken due to a large distortion, and consequently, it is difficult to use the glass substrate.

In the semiconductor mechanical quantity measuring apparatus according to the present invention, since the mounting board is provided on the sensor chip rear surface made of a monocrystalline silicon substrate and the sensor chip is provided on the object to be measured via the mounting board, even if a large distortion occurs in the object to be measured, the mounting board 4 can control a distortion occurring on the semiconductor monocrystalline substrate.

If the mounting board 4 is made of metal material, even when a large distortion occurs in the object to be measured, the mounting board is not broken because of high elasticity limit of the metal material, and a distortion occurring on the sensor chip made of the semiconductor monocrystalline substrate can be reduced.

Further, if the mounting board is made of a metal material having a lower Young's modulus than silicon, the distortion of the object to be measured is alleviated by the mounting board, and a distortion occurring on the sensor chip can be effectively reduced. Also, the mounting board is not broken because it is made of a metal material.

Furthermore, if the mounting board is made of a metal material having a higher Young's modulus than the monocrystalline silicon, the mounting board is not broken and the mechanical quantity measuring apparatus having high sensitivity can be provided. When a metal material having a higher Young's modulus than monocrystalline silicon is used for the mounting board, since the sensitivity of the sensor is higher than that of a sensor using a material having a lower Young's modulus and tensile strength is strong, there is an advantage that the mounting board 4 is difficult to break. Such a mechanical quantity measuring apparatus is particularly effective for the case where an object to be measured is made of a material having a higher Young's modulus than that of monocrystalline silicon. For example, such an apparatus is suitable for measuring a distortion of a steel material used in a large building and the like. In this case, the mounting board 4 can be attached to a steel material by spot welding and reliability in an interface between the mounting board and the object to be measured can be advantageously enhanced.

If the mounting board 4 is made of a metal material, there is an advantage that it is insusceptible to water or the like and is excellent in resistance to climatic conditions. Further, owing to high thermal conductivity of metal, there is an advantage that temperature uniformity of the sensor chip is enhanced.

Further, if the mounting board 4 is made of a filler-containing resin material, a resin having a high Young's modulus is obtained, and it is possible to prevent the reduction in the sensitivity due to the mounting board 4. Further, in the case where the filler-containing resin material is used, even when a large distortion occurs in the mounting board 4, the board is not broken and a distortion occurring in the senor chip made of the monocrystalline silicon substrate 1 can be reduced. If the mounting board 4 is made of resin having no filler, since the Young's modulus of the resin is low, a distortion of the object to be measured is not transmitted to the sensor chip and the mechanical quantity measuring apparatus cannot exert its functions as a measuring apparatus. By using the filler-containing resin, the Young's modulus of the resin can be increased, and a distortion of the object to be measured can be transmitted to the distortion detecting unit 2 in the sensor chip. In addition, since the Young's modulus of the filler-containing resin is lower than that of silicon, the resin itself forming the mounting board 4 deforms more easily than silicon and is not broken due to the distortion of the object to be measured. Furthermore, since the linear expansion coefficient is decreased by adding the filler, it is possible to alleviate an influence caused by extension/contraction of the mounting board due to a temperature change. Accordingly, it is possible to provide a highly reliable mechanical quantity measuring apparatus in which a distortion of an object to be measured can be efficiently and appropriately reduced and the mounting board and the sensor chip are not broken. The mechanical quantity measuring apparatus comprising the mounting board made of filler-containing resin is particularly effective for the case where the Young's modulus of the object to be measured is lower than that of silicon and a large distortion occurs.

As described above, since the mounting board 4 is provided on the sensor chip rear surface made of the silicon substrate 1, the highly reliable mechanical quantity measuring apparatus in which the silicon substrate is not broken can be provided.

Further, if the sensor chip is arranged at the center of the mounting board 4, since it is possible to reduce a variation in the sensitivity due to the influence of the ends of the mounting board 4, it is possible to perform the measurement with high accuracy. Further, if the sensor chip is arranged so that a distance between the end of the mounting board 4 and the end of the chip is equal to or larger than the thickness of the mounting board, since the sensor chip is not influenced by the distortion alleviation at the end of the mounting board, it is possible to perform the measurement with high accuracy.

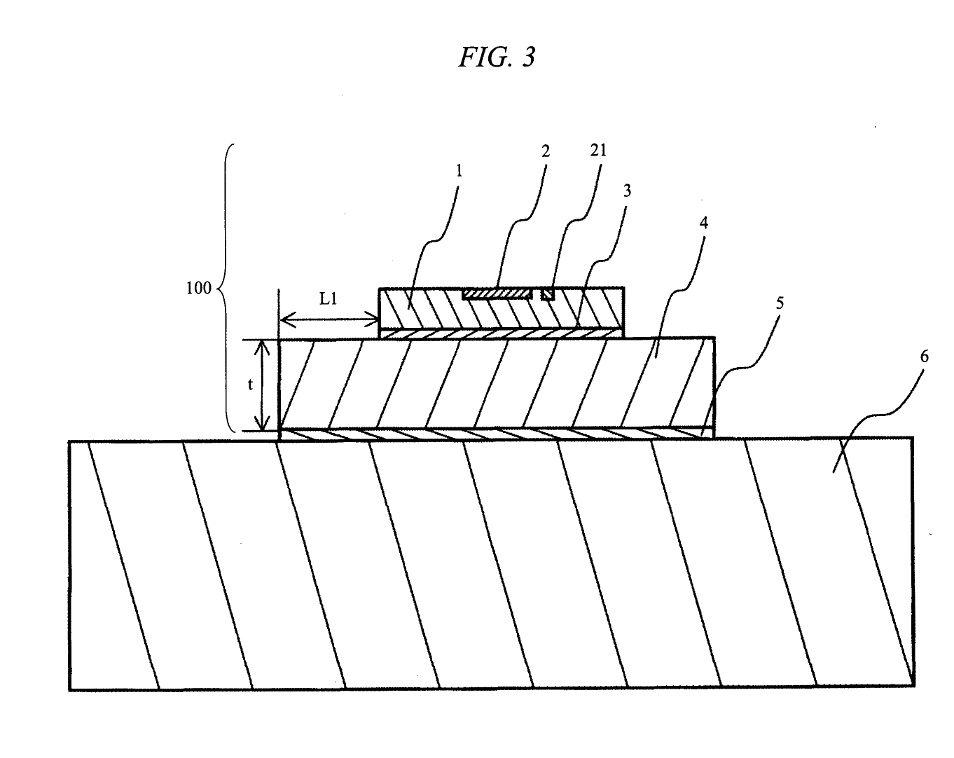

Furthermore, if the mounting board 4 made of metal material is used, since the metal is generally large in the linear expansion coefficient, there is concern that expansion of the metallic mounting board 4 due to a temperature change is measured as a distortion by mistake. However, by providing a temperature sensor 21 on the same chip of the mechanical quantity measuring apparatus as shown in FIG. 3, it is possible to remove a thermal distortion caused by a difference in the linear expansion coefficient between the mounting board 4 and the sensor chip having the monocrystalline silicon substrate 1. Note that the temperature sensor 21 is preferably a P-N junction diode formed on the silicon substrate 1. In this manner, the temperature sensor can accurately measure a change in temperature near the distortion detecting unit 2 without being influenced by a change in distortion occurring in the silicon substrate 1. Also, since the metallic mounting board 4 is small in thermal resistance, it has an effect of making the temperature of the entire mechanical quantity measuring apparatus uniform, and the temperature sensor 21 can easily detect a temperature effective for correction.

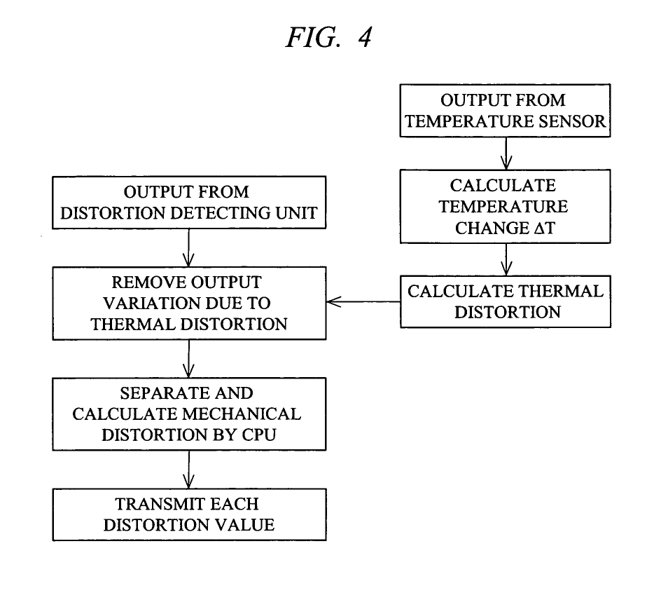

The effect obtained by providing the distortion detecting unit 2 and the temperature sensor 21 on the same chip will be described with reference to a flowchart of FIG. 4. First, the temperature sensor 21 measures a temperature change AT during distortion measurement and calculates a thermal distortion caused by the difference in linear expansion coefficient between the silicon substrate 1 and the metallic mounting board 4 due to temperature change. By this means, when each of the distortion components is separately calculated from the output of the distortion detecting unit 2, the thermal distortion component can be removed in the calculation. Therefore, even when the mounting board is made of a metal having a larger linear expansion coefficient than silicon, it is possible to remove the thermal distortion occurring due to the difference in the linear expansion coefficient, and the semiconductor mechanical quantity measuring apparatus with higher accuracy can be obtained.

Also, since the distortion detecting unit 2 and the temperature sensor 21 are formed on the silicon substrate, they can be manufactured through a semiconductor process. Therefore, they can be mounted together with a digital circuit, a memory circuit, a communication circuit and the like of other CPU. Further, there is also an advantage that mass production with high accuracy and at low cost is possible because semiconductor manufacturing equipment can be used. Even when the mounting board 4 is not metallic, since the silicon substrate 1 and the mounting board 4 have the linear expansion coefficients, it is effective for highly-accurate measurement to perform the measurement while correcting a thermal distortion of the mounting board 4 by the temperature sensor 21.

FIG. 3 is a sectional view showing main portions of the mechanical quantity measuring apparatus 100 which is the mechanical quantity measuring apparatus according to the first embodiment provided on an object to be measured. The mechanical quantity measuring apparatus 100 is provided on an object to be measured 6 via an adhesion layer 5. Thus, a distortion occurs also in the mechanical quantity measuring apparatus 100 due to a distortion change of the object to be measured 6, and the amount of distortion can be calculated from the output change of the distortion detecting unit 2. The adhesion layer 5 can be made of, for example, epoxy-based adhesive material or phenol-based adhesive material.

Although FIG. 3 shows the case where the mechanical quantity measuring apparatus 100 is provided on a surface of the object to be measured 6, even when the mounting board is provided so that a part or all of the mounting board is embedded in the object to be measured 6, similar effects can be obtained.

### Second Embodiment

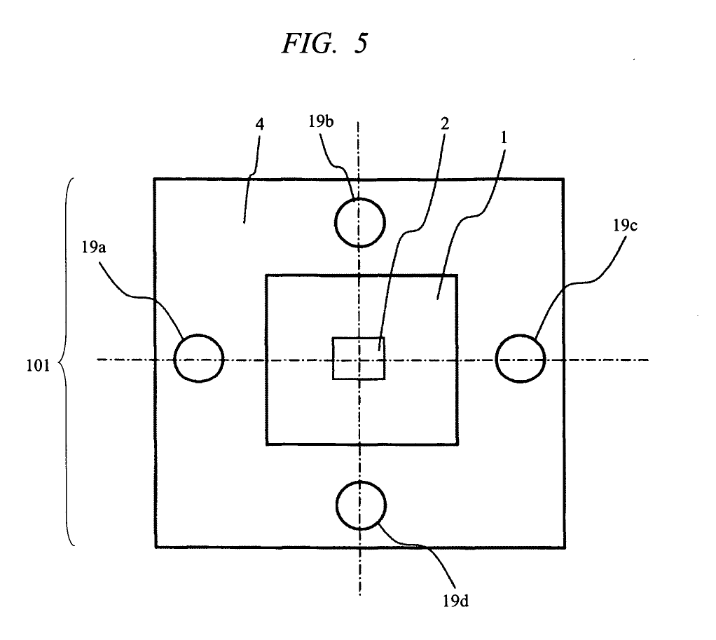

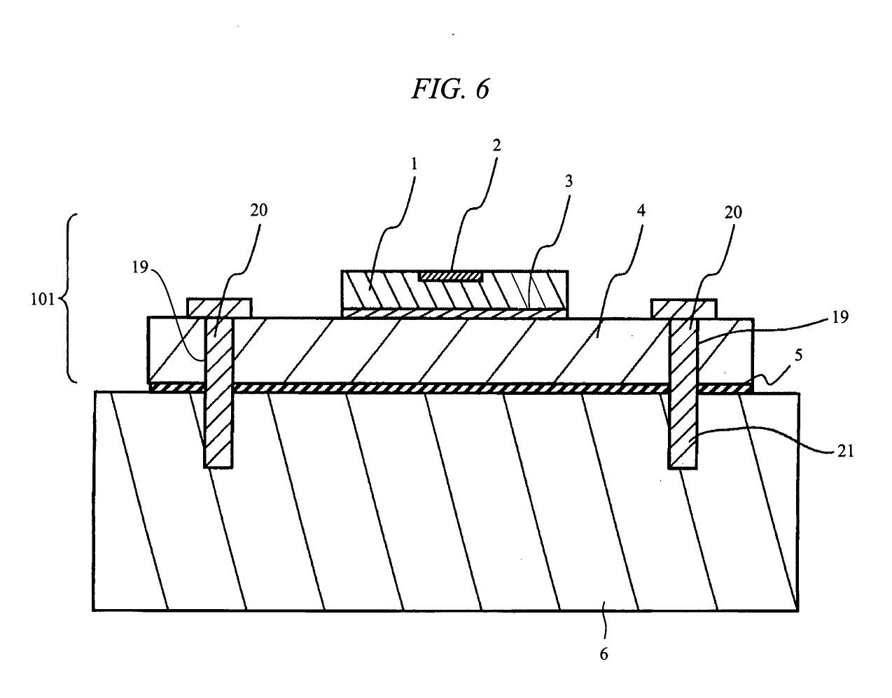

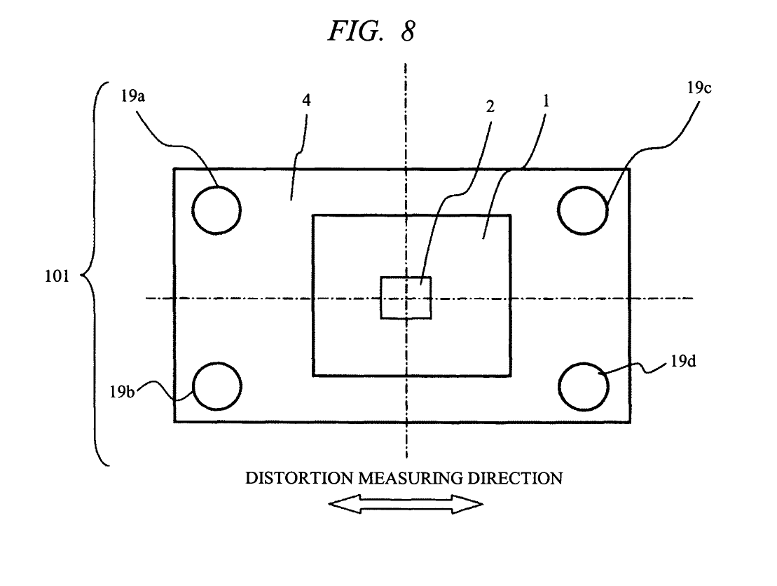

Next, a second embodiment of the present invention will be described with reference to FIG. 5 to FIG. 8. FIG. 5 and FIG. 6 show a sectional structure and planar structure of main portions of the mechanical quantity measuring apparatus according to the second embodiment, respectively, and the elements common to those in the first embodiment are denoted by the same reference numerals.

In the mechanical quantity measuring apparatus 101 according to the present embodiment shown in FIG. 5 and FIG. 6, screw holes 19a, 19b, 19c and 19d are provided outside each side of the silicon substrate 1 in the mounting board 4 of the mechanical quantity measuring apparatus 100 according to the first embodiment shown in FIG. 1 and FIG. 2. Note that the distances from the ends of the silicon substrate 1 to the respective screw holes 19a, 19b, 19c, and 19d are approximately equal to each other. Also, the distortion detecting unit 2 is provided substantially at the center of the square with the screw holes 19a, 19b, 19c and 19d as its apexes.

In this embodiment, the mechanical quantity measuring apparatus can be provided on an object to be measured by screws and bolts, and there is no measurement error caused by nonlinear behavior due to an adhesive or adhesive variation. Therefore, it is possible to measure a distortion with high accuracy.

FIG. 6 shows a sectional structure of main portions when the mechanical quantity measuring apparatus 101 according to the second embodiment is provided on an object to be measured. The mechanical quantity measuring apparatus 101 is screwed on the object to be measured 6 by screws 20 inserted into screw holes 21 formed in the object to be measured 6 and the screw holes 19 formed in the mounting board 4. Thus, when a distortion occurs in the object to be measured 6, a distortion occurs also in the mechanical quantity measuring apparatus 100, and the amount of distortion can be calculated from the output change of the distortion detecting unit 2. A total of four screw holes 19a, 19b, 19c and 19d are provided outside the respective sides of the silicon substrate 1 on the mounting board 4 so that at least one hole is provided for each side thereof to fix the apparatus to the object to be measured. By this means, it is possible to accurately detect a distortion even in a biaxial distortion field.

In the present embodiment, although the screw holes 19 are provided outside the sides of the mounting board 4 so that one hole is provided for each side, it is not always necessary that only one screw hole is provided at each side, and several screw holes 19 may be provided at each side. In this case, there is also an advantage that distortion following capability is enhanced. Further, only the screws 20 or both the screws 20 and the adhesion layer 5 can be used for the attachment.

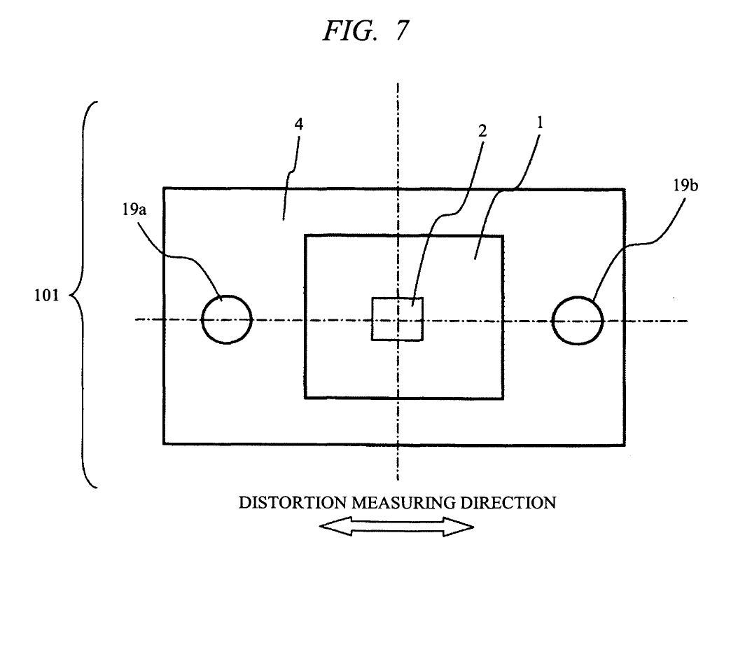

In the mechanical quantity measuring apparatus 102 according to the present embodiment shown in FIG. 7, the screw holes 19 are provided outside the two opposite sides of the silicon substrate 1. Note that the distances from the ends of the silicon substrate 1 to the screw holes 19 are approximately equal to each other. Further, the distortion detecting unit is provided substantially at the middle of the two screw holes 19a and 19b. The present embodiment is particularly effective for the case where the sensor chip for a single-axial distortion detection is mounted, and the screw holes 19 are provided at both sides of the distortion detecting unit 2 in the distortion measuring direction. By designing the mounting board 4 to be a rectangular shape and matching its longitudinal direction and the distortion measuring direction, it becomes possible to easily recognize a distortion measuring direction and handle the apparatus. Further, since the area of the mounting board can be reduced compared with the case where the screw holes are provided at the four sides of the mounting board 4, it is possible to reduce the material cost.

In the embodiment shown in FIG. 7, although the screw holes 19 are provided outside the opposite sides of the silicon substrate 1 so that one hole is provided for each side, it is not always necessary that only one screw hole is provided at each side, and several screw holes 19 may be provided at each side. In this case, there is also an advantage that distortion following capability is enhanced.

### Third Embodiment

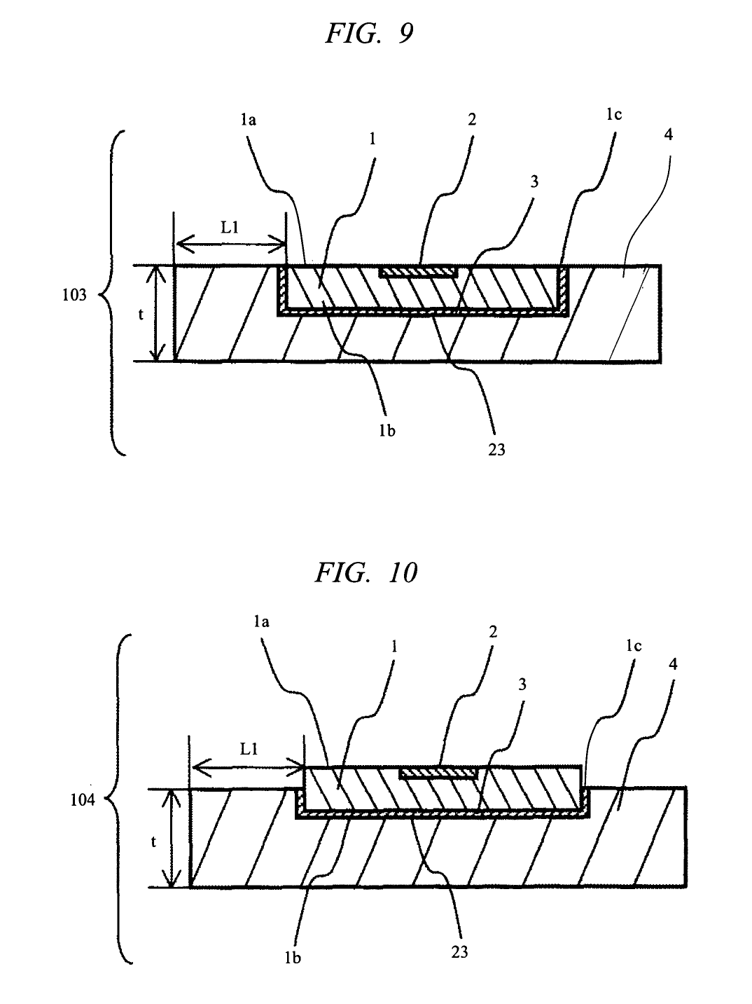

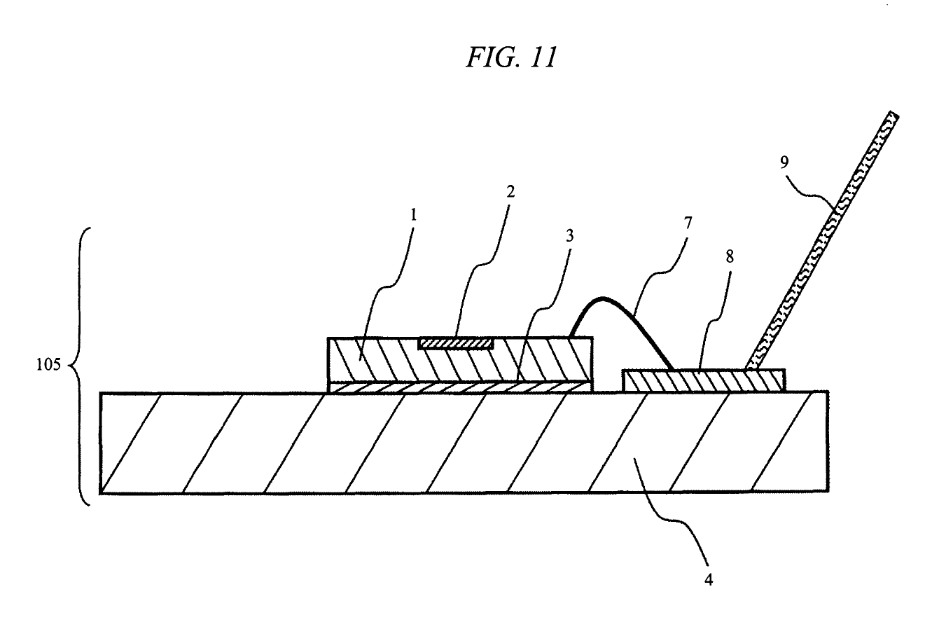

Next, a third embodiment of the present invention will be described with reference to FIG. 9 and FIG. 10. FIG. 9 shows a sectional structure of main portions of a mechanical quantity measuring apparatus according to the third embodiment, and the elements common to those in the first embodiment are denoted by the same reference numerals.

In the mechanical quantity measuring apparatus 100 according to the first embodiment shown in FIG. 1, the silicon substrate 1 is provided on the surface of the mounting board 4 via the adhesion layer 3. Meanwhile, in the mechanical quantity measuring apparatus 103 according to the present embodiment shown in FIG. 9, the mounting board is thicker around the area where the sensor chip is attached than in the area where the sensor chip is attached, and the rear surface 1b and the sidewalls 1c of the silicon substrate 1 are opposed to the mounting board 4. In other words, the silicon substrate 1 is embedded in a groove 23 formed in the mounting board 4. The silicon substrate 1 and the mounting board 4 are connected via the adhesion layer 3. Other structure is the same and similar effects as those in the first embodiment can be obtained. According to the present embodiment, since a groove 23 which is adjusted for the shape of the mounting board 4 and is slightly larger than the silicon substrate 1 is formed in the mounting board 4, there is an advantage that alignment when mounting the silicon substrate 1 on the mounting board 4 is facilitated. Also, since a distortion of the mounting board 4 is transmitted not only from the rear surface 1b of the silicon substrate 1 but also from the sidewall 1c thereof, the distortion sensitivity is also enhanced. Further, when the mechanical quantity measuring apparatus 103 according to the present embodiment is provided on an object to be measured, it may de attached on a surface of the object to be measured by an adhesive material or may be provided on the object to be measured by screws by providing the screw holes 19.

Also, it is not always necessary to embed the entire chip sensor in the mounting board 4, and the structure as shown in FIG. 10 is also preferable in which a part of the silicon substrate 1 is embedded in the groove 23 formed in the mounting board 4. The silicon substrate 1 and the mounting board 4 are connected via the adhesion layer 3. Other structure is the same and similar effects as those in the first embodiment can be obtained.

### Fourth Embodiment

Next, a fourth embodiment of the present invention will be described with reference to FIG. 11 to FIG. 16. FIG. 11 to FIG. 16 show a sectional structure and planar structure of main portions of the mechanical quantity measuring apparatus according to the present embodiment, respectively, and the elements common to those in the first embodiment are denoted by the same reference numerals.

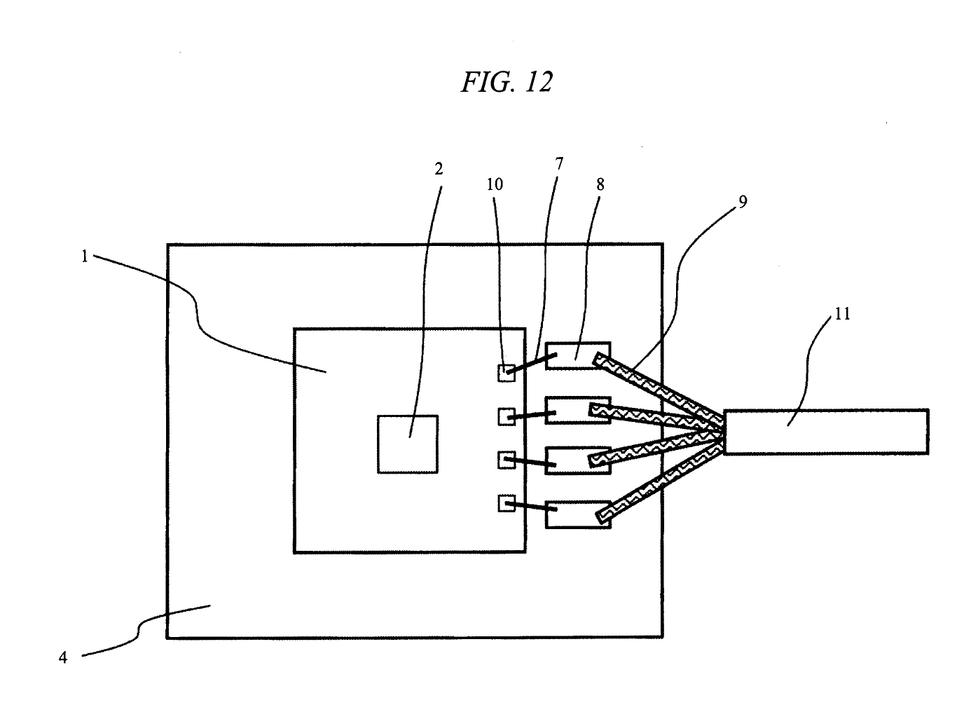

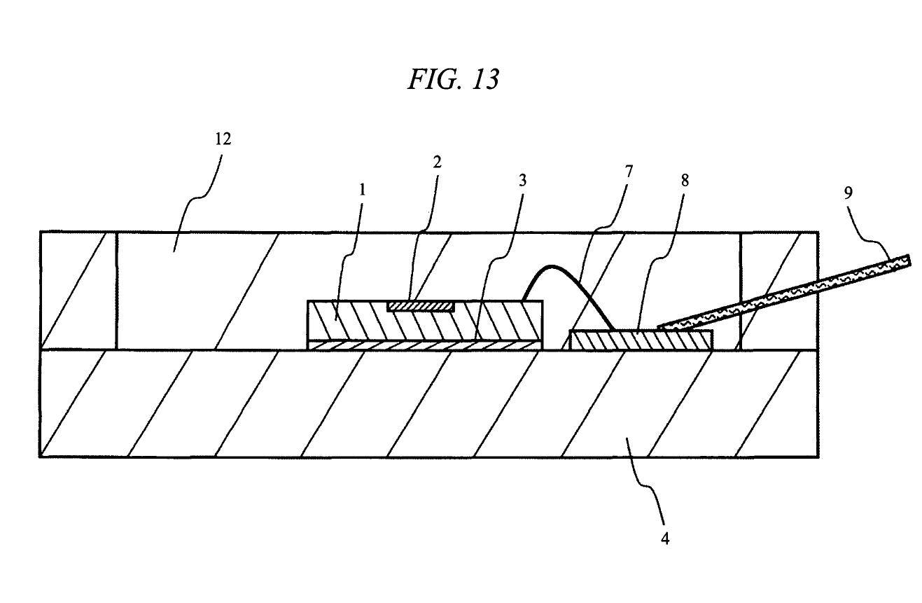

In the mechanical quantity measuring apparatus shown in FIG. 11 and FIG. 12, wirings for extracting an electric signal from the sensor chip are provided for the mechanical quantity measuring apparatus 100 according to the first embodiment shown in FIG. 1. The silicon substrate 1 is provided on the upper surface of the mounting board 4 via the adhesion layer 3 and terminal pedestals 8 are provided on the upper surface of the mounting board 4. Pads 10 electrically connected to the distortion detecting unit are provided on the surface of the silicon substrate 1, and the terminal pedestals 8 and the pads 10 are electrically connected via the wirings 7. For example, the wirings 7 can be formed by wire bonding or the like. Although the silicon substrate 1 has limitations in thickness of the wiring directly connected thereto and connection strength thereof is not so strong, the wiring through the pads 10 using wirings 9 can enhance the connection strength thereof, and it is possible to prevent the disconnection caused by pulling the wirings 9 when handling the mechanical quantity measuring apparatus 100.

Since the electric wirings 9 are connected to the terminal pedestals 8, it is possible to connect an external apparatus. Also, by providing a shield 11 outside the electric wirings 9, it becomes possible to reduce the electric noise.

Note that, when the mechanical quantity measuring apparatus 105 according to the present embodiment is attached on an object to be measured, it can be attached to a surface of the object by an adhesive material or can be attached on the object to be measured by screws by forming the screw holes 19 in the same manner as that in FIG. 5 to FIG. 8.

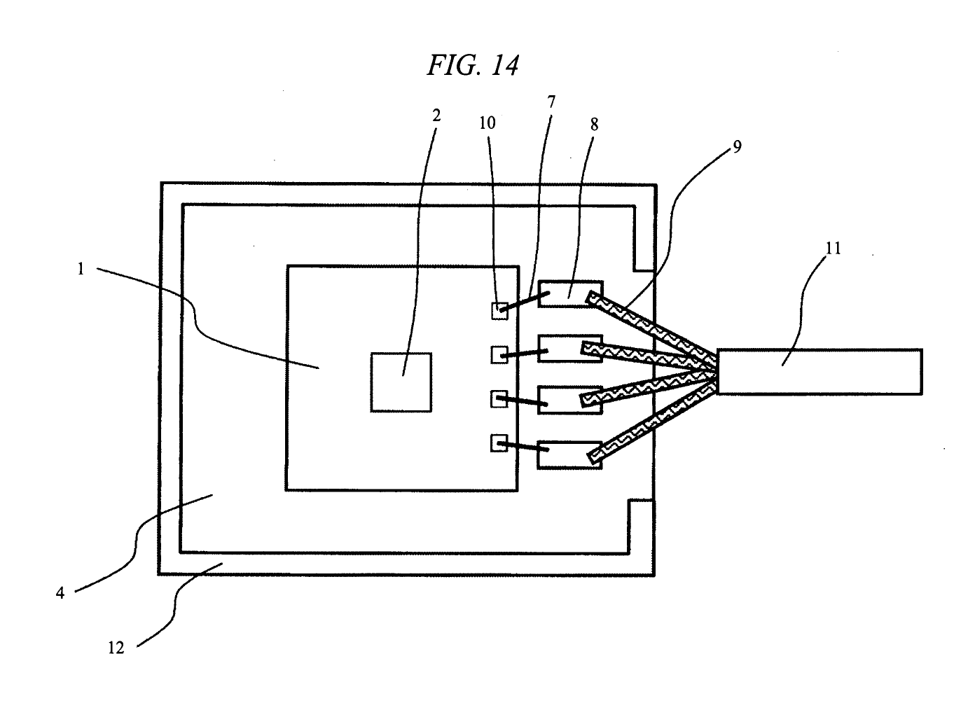

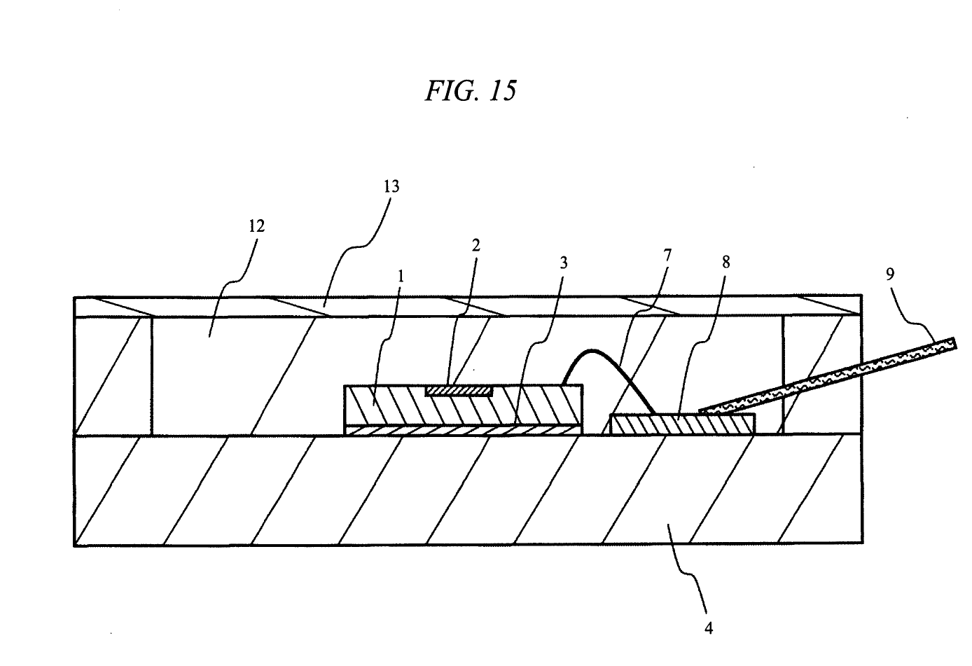

Further, in the mechanical quantity measuring apparatus shown in FIG. 13 and FIG. 14, a sidewall 12 is provided for the mounting board 4 in the mechanical quantity measuring apparatus shown in FIG. 11 and FIG. 12. The sidewall 12 is integrally formed of the same material as the mounting board 4, thereby restricting the generation of a thermal distortion at the time of temperature change. Other structure is the same and similar effects as those in the first embodiment can be obtained. In the case where the sidewall 12 is provided as shown in the present embodiment and an area where the mounting board 4 has a thickness larger than that in the area where the sensor chip is attached is provided around the area where the sensor chip is attached, since a load can be applied to the sidewall 12 when providing the mechanical quantity measuring apparatus to an object to be measured by an adhesive material, attachment work is advantageously facilitated. Also, when the sensor chip is covered with a covering material such as resin, the formation of the resin is facilitated because it is filled inside the sidewall 12.

Note that, when the mechanical quantity measuring apparatus according to the present embodiment is attached on an object to be measured, it can be attached to a surface of the object by an adhesive material or can be attached on the object to be measured by screws by forming the screw holes 19 in the mounting board 4.

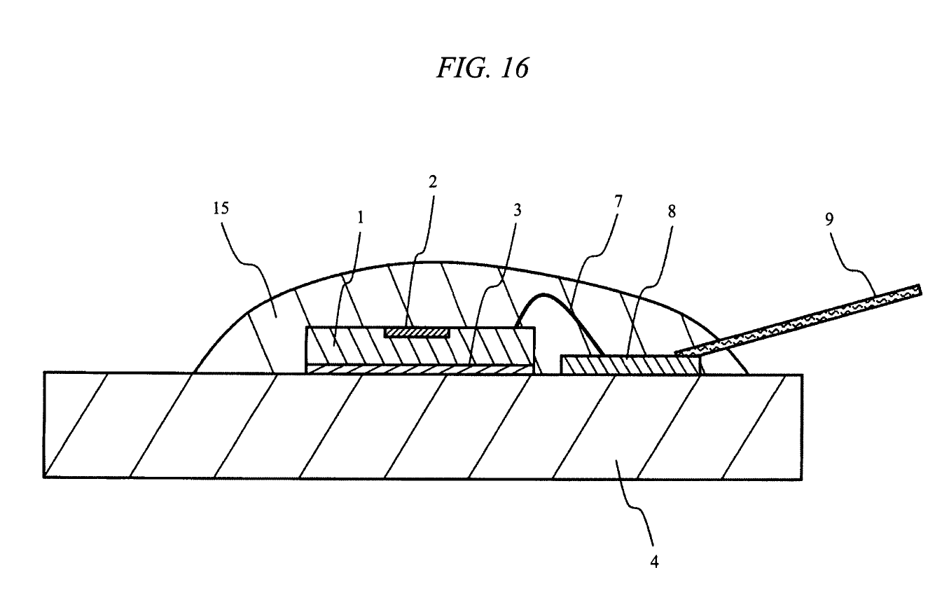

Also, in the mechanical quantity measuring apparatus shown in FIG. 15, a cover 13 covering the entire area having the sensor chip is provided on the sidewall according to the present embodiment shown in FIG. 13 and FIG. 14. By providing the cover 13, resistance to climatic conditions can be enhanced. The cover 13 is made of the same material as the sidewall 12 and the mounting board 4, thereby restricting the generation of a thermal distortion at the time of temperature change.

Further, it is possible to enhance the resistance to climatic conditions also by providing filler (not shown) in an area surrounded by upper surface of the mounting board 4 and the sidewall 12 so as to cover the sensor chip mainly made of the silicon substrate 1, the terminal pedestals 8, the wirings 7 and others with resin instead of providing the cover 13. If the cover 13 is used together, it is possible to further enhance the resistance to climatic conditions.

Further, it is possible to enhance the resistance to climatic conditions also by providing a covering material 15 such as resin so as to cover the sensor chip made of the silicon substrate 1, the terminal pedestals 8, the wirings 7 and others without providing the sidewall 12 or the like as shown in FIG. 16.

### Fifth Embodiment

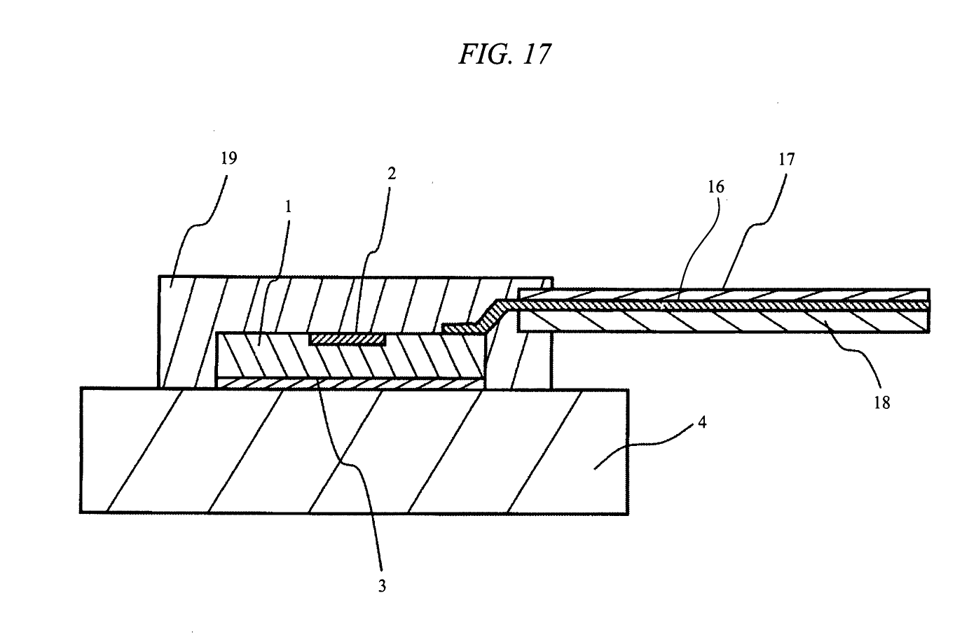

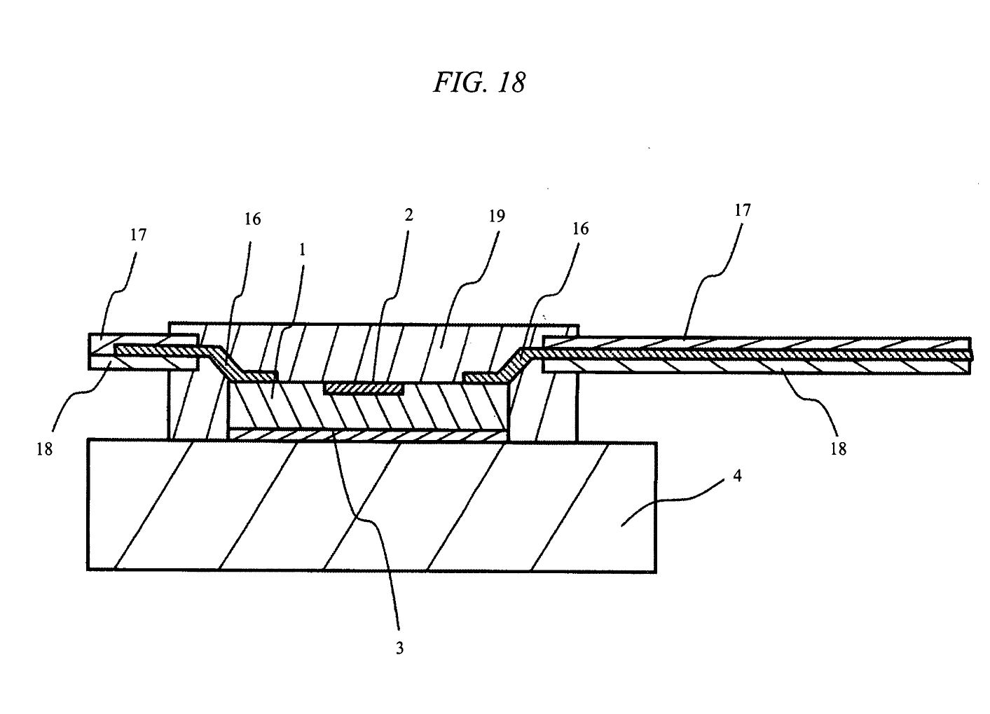

Next, a fifth embodiment of the present invention will be described with reference to FIG. 17 to FIG. 19. FIG. 17 shows a sectional structure of main portions of a mechanical quantity measuring apparatus according to the fifth embodiment, and the elements common to those in the first embodiment are denoted by the same reference numerals.

In the mechanical quantity measuring apparatus shown in FIG. 17, the silicon substrate 1 on which the distortion detecting unit 2 is provided and wirings 16 provided on a resin film 18 are electrically connected to each other. Note that it is preferable that the surface of the wiring 16 is covered with resin 17 on the resin film 18. For example, a structure where the wiring is mounted by the TAB (tape automated bonding) is employed. Also, the entire surface of the silicon substrate 1 on which the distortion detecting unit 2 is provided is covered with the screw holes 19 such as resin. In this case, it is preferable that the exposed wiring 16 is also covered entirely.

According to the present embodiment, since the wirings and the sensor chip are electrically connected, the mounting board 4 can be reduced in size. Therefore, it is possible to reduce the cost thereof. Also, since the sensor chip and the wirings 16 are covered with the same screw holes 19, it is possible to enhance resistance to climatic conditions and to enhance connection strength.

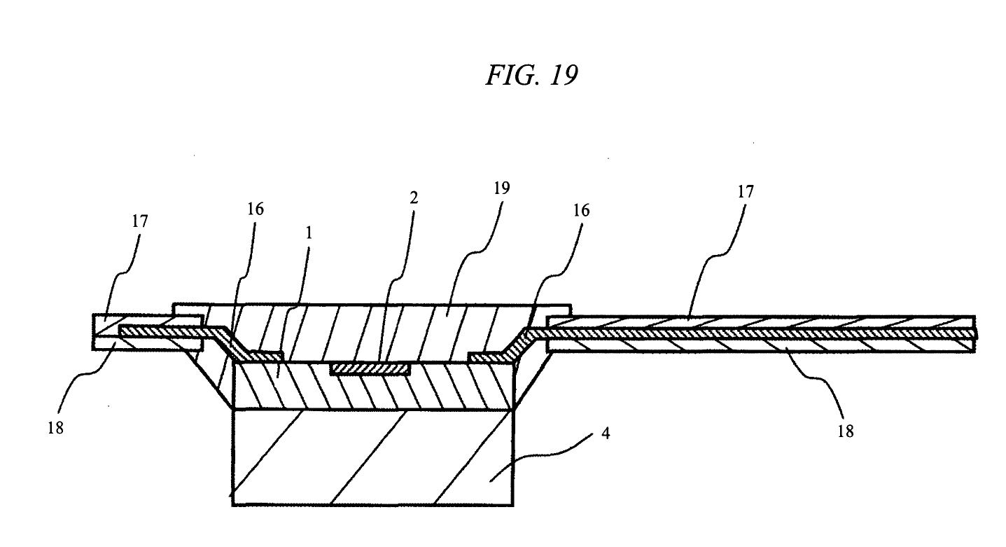

Note that, when the mechanical quantity measuring apparatus according to the present embodiment is attached on an object to be measured, it can be attached to a surface thereof by an adhesive material, or it can be attached-on the object to be measured by screws by forming the screw holes in the mounting board 4. Also, even when the wirings 16 connected to the sensor chip are connected to two or more sides instead of one side as shown in FIG. 19, similar effects can be obtained. In this case, since the wirings 16 connected to the sensor chip are symmetrically arranged, a thermal distortion is also symmetrical and consequently accuracy in the correction of distortion due to a temperature change can be advantageously enhanced.

In the present embodiment, the case where the screw holes 19 are provided also on the mounting board 4 has been described. However, it is not always necessary to provide the screw holes 19 on the mounting board 4 if it is provided at least on the upper surface of the distortion sensor, preferably on the upper surface and the sidewall of the sensor.

In the mechanical quantity measuring apparatus shown in FIG. 19, the mounting board 4 has the same size as that of the silicon substrate 1.

In the mechanical quantity measuring apparatus according to the present embodiment, since the silicon substrate 1 and the mounting board 4 can be collectively formed, it is possible to reduce the number of manufacturing steps.

### Sixth Embodiment

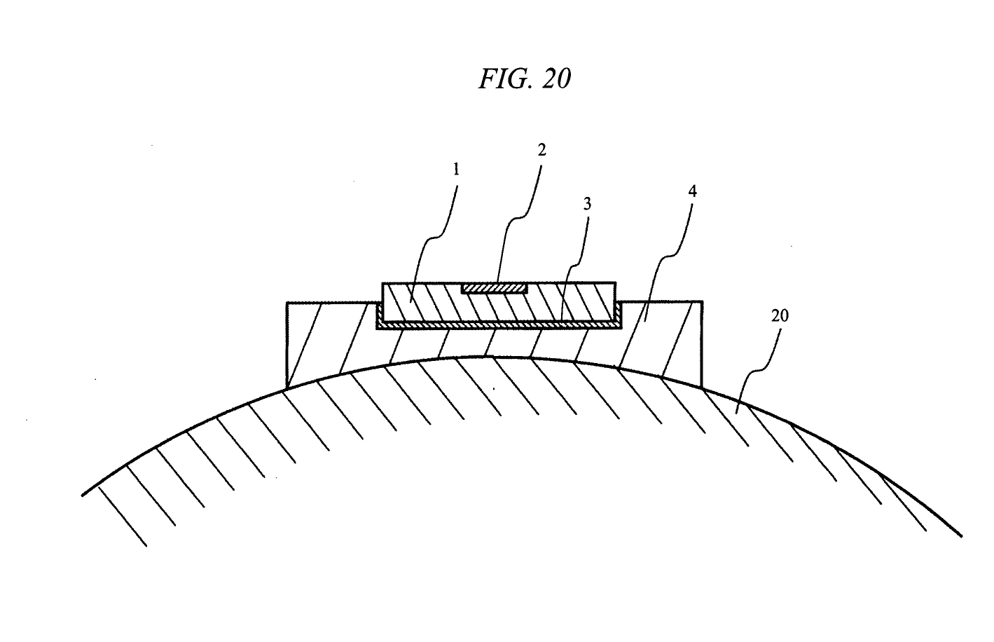

Next, a sixth embodiment of the present invention will be described with reference to FIG. 20.

In the mechanical quantity measuring apparatus shown in FIG. 20, the rear surface of the mounting board 4 in the mechanical quantity measuring apparatus according to the first embodiment is not flat but curved. The surface on which the sensor chip is mounted is formed of a single plane or several planes as shown in FIG. 9 and FIG. 10 in conformity to the shape of the silicon substrate 1.

In the mechanical quantity measuring apparatus according to the present embodiment, it is possible to easily provide the mechanical quantity measuring apparatus on a curved surface 20. Since the silicon substrate 1 has a flat surface, it is difficult to attach it on an object to be measured having a curved surface. However, by using this mounting board 4, the apparatus can be attached on the object to be measured having a curved surface. Note that the mounting surface may be a spherical surface or an uneven surface in conformity to the shape of an object to be measured. Also, the apparatus can be attached on the surface of an object to be measured by an adhesive material or can be provided on the object to be measured by screws by forming the screw holes in the mounting board 4.

What is claimed is:

1. A mechanical quantity measuring apparatus comprising:
a sensor chip having a monocrystalline semiconductor substrate and a distortion detecting unit which is formed on the semiconductor substrate and detects extension/contraction in an in-plane direction of the semiconductor substrate; and
a mounting board having a mounting surface attached to an object to be measured and a surface which is opposite to the mounting surface and to which one main surface of the sensor chip is attached,
wherein extension/contraction of an object to be measured is measured through the mounting board.

2. The mechanical quantity measuring apparatus according to claim 1,
wherein a distance from an end of the sensor chip to an end of the mounting board is larger than a thickness of the mounting board.

3. The mechanical quantity measuring apparatus according to claim 1,
wherein the sensor chip is attached to the mounting board by a surface opposite to a surface on which the distortion detecting unit is provided.

4. A mechanical quantity measuring apparatus comprising:
a sensor chip having a monocrystalline semiconductor substrate and a distortion detecting unit which is formed on the semiconductor substrate and detects extension/contraction in an in-plane direction of the semiconductor substrate; and
a mounting board made of a metal material and having a mounting surface attached to an object to be measured and a surface which is opposite to the mounting surface and to which one main surface of the sensor chip is attached.

5. The mechanical quantity measuring apparatus according to claim 4,
wherein Young's modulus of the mounting board is lower than that of the semiconductor substrate.

6. A mechanical quantity measuring apparatus comprising:
a sensor chip having a monocrystalline semiconductor substrate and a distortion detecting unit which is formed on the semiconductor substrate and detects extension/contraction in an in-plane direction of the semiconductor substrate; and
a mounting board having a mounting surface attached to an object to be measured and a surface which is opposite to the mounting surface and to which one main surface of the sensor chip is attached,
wherein Young's modulus of the mounting board is higher than that of the semiconductor substrate.

7. The mechanical quantity measuring apparatus according to claim 6,
wherein the mounting board is made of metal.

8. A mechanical quantity measuring apparatus comprising:
a sensor chip having a monocrystalline semiconductor substrate and a distortion detecting unit which is formed on the semiconductor substrate and detects extension/contraction in an in-plane direction of the semiconductor substrate;
a mounting board having a mounting surface attached to an object to be measured and a surface which is opposite to the mounting surface and to which one main surface of the sensor chip is attached; and
temperature detecting means,
wherein a value of measured distortion is corrected using a detected temperature by the temperature detecting means.

9. The mechanical quantity measuring apparatus according to claim 8,
wherein the temperature detecting means corrects an influence due to expansion of the mounting board.

10. The mechanical quantity measuring apparatus according to claim 8,
wherein the mounting board is made of a metal material.

11. A mechanical quantity measuring apparatus comprising:
a sensor chip having a monocrystalline semiconductor substrate and a distortion detecting unit which is formed on the semiconductor substrate and detects extension/contraction in an in-plane direction of the semiconductor substrate; and
a mounting board having a mounting surface attached to an object to be measured and a surface which is opposite to the mounting surface and to which one main surface of the sensor chip is attached,
wherein the mounting board is made of filler-containing resin.

12. The mechanical quantity measuring apparatus according to claim 1,
wherein the mounting board has a structure for inserting screws.

13. The mechanical quantity measuring apparatus according to claim 1,
wherein the sensor chip is embedded in the mounting board.

14. The mechanical quantity measuring apparatus according to claim 1,
wherein terminal pedestals are provided on an upper surface of the mounting board,
the distortion detecting unit provided on the sensor chip and the terminal pedestals are electrically connected, and
the terminal pedestals are electrically connected to outside.

15. The mechanical quantity measuring apparatus according to claim 1,
wherein the sensor chip is covered with a covering material.

16. The mechanical quantity measuring apparatus according to claim 1,
wherein an area where the mounting board has a thickness larger than that in an area where the sensor chip is attached is provided around the area where the sensor chip is attached.

17. The mechanical quantity measuring apparatus according to claim 1,
wherein a mounting surface of the mounting board is curved.
